(19) United States
(12) Patent Application Publication
(10) Pub. No.: US 2004/0146009 A1
(43) Pub. Date: Jul. 29, 2004

(54) Method and apparatus for facilitating a signal quality measurement in a TDMA system

(75) Inventor: Jean Khawand, Miami, FL (US)

Correspondence Address: Law Offices of David G. Posz, Suite 200, 2000 L Street, N.W., Washington, DC, 20036, US

(73) Assignee: MOTOROLA, INC.

(21) Appl. No.: 10/353,652

(22) Filed: Jan. 29, 2003

(51) Int. Cl. H04L 12/26

(52) U.S. Cl. 370/252

(57) ABSTRACT

A TDMA communication system (100) includes a plurality of subscriber units (107, 108) and has a sequentially numbered frame structure including first and second subslots used for transmissions by the subscriber units. The second subslot overlaps with an optimum time period (304, 318) for making a signal quality measurement of a neighbor cell. A fixed portion of the communication system communicates (402) a first control value to a first subscriber unit; and the first subscriber unit transmits (404) during the first subslot (326) in even-numbered frames (324) and during the second subslot (312) in odd-numbered frames (314), in response to the first control value, thereby allowing neighbor cell signal quality measurements during the optimum time period in alternate frames.

### FIELD OF THE INVENTION

This invention relates in general to wireless communication systems, and more specifically to a method and apparatus for facilitating a signal quality measurement in a TDMA system.

### BACKGROUND OF THE INVENTION

In a TDMA system, the structure of the TDMA frame may overlap the receive (RX) and transmit (TX) time slots of a subscriber unit (SU) with the optimal time to perform a neighbor-cell signal quality measurement. Such is the case, for example, in systems utilizing the Integrated Digital Enhanced Network 3:1 TDMA protocol. The TX slot assigned to the SU can overlap the beginning of the neighbor cell RX slot where the sync symbols and color codes are located. In the prior-art systems this has forced the SU to estimate the signal quality using the pilot symbols from the middle of the neighbor slot. This measurement is more computationally intensive and less accurate than a partial neighbor slot signal quality measurement made during the transmission of the sync symbols and the color codes.

Thus, what is needed is a method and apparatus for facilitating a signal quality measurement in a TDMA system. Preferably, the method and apparatus will allow all SUs in the system to make the measurement during the transmission of the sync symbols and the color codes by the neighbor cell.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a TDMA communication system.

FIG. 2 is a timing diagram depicting communications of a prior-art subscriber unit.

FIG. 3 is a timing diagram depicting communications of a subscriber unit in accordance with the present invention.

FIG. 4 is a flow chart depicting operation of the TDMA communication system in accordance with the present invention.

FIG. 5 is an electrical block diagram of the subscriber unit in accordance with the present invention.

FIG. 6 is an electrical block diagram of a controller in accordance with the present invention.

### DETAILED DESCRIPTION OF THE PREFERRED EMBODIMENT

In overview, the present disclosure concerns wireless communications systems in which mobile subscriber units (SUs) monitor transmissions of cells that are neighbors of or proximate to a currently preferred cell. More particularly, various inventive concepts and principles embodied as methods and apparatus for facilitating a signal quality measurement in a TDMA system will be discussed and disclosed. The communication systems of particular interest are those being deployed and developed for cellular telephone communications, although the concepts and principles have application in other systems and devices.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit the invention in any manner. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in one or more conventional digital signal processors (DSPs), or with integrated circuits (ICs) such as custom or application specific ICs. It is expected that one of ordinary skill, notwithstanding possibly significant effort and many design choices motivated by, for example, available time, current technology, and economic considerations, when guided by the concepts and principles disclosed herein will be readily capable of programming such DSPs, or generating such ICs with minimal experimentation. Therefore, in the interest of brevity and minimization of any risk of obscuring the principles and concepts according to the present invention, further discussion of such DSPs and ICs, if any, will be limited to the essentials with respect to the principles and concepts employed by the preferred embodiments.

Referring to FIG. 1, an electrical block diagram 100 of a TDMA communication system comprises a controller 101 coupled to base stations 102, 103, 104, and interfaced to an external network through a telephone interface 106. The base stations 102, 103, 104 individually support portions of a geographic coverage area containing transceivers or subscriber units (SUs) 107, 108. The SUs 107, 108 interface with the base stations 102, 103, 104 using a TDMA protocol or air interface protocol, such as the Integrated Digital Enhanced Network protocol commercially available from Motorola in iDEN™ systems.

The geographic coverage area of the communication system 100 is divided into regions or cells, which are individually serviced by the base stations 102, 103, 104, also referred to herein as cell servers. An SU operating within the system 100 selects a particular cell server as its primary interface for receive and transmit operations within the system. For example, SU 107 has cell server 102 as its primary cell server, and SU 108 has cell server 104 as its primary cell server. Preferably, an SU selects a cell server, which provides the best or an acceptable communication interface into the system. This ordinarily will depend on the signal quality of communication signals between the SU and the particular cell server. As an SU moves between various geographic locations in the coverage area, a hand-off or hand-over may be necessary to another cell server, which will then function as the primary cell server. Accordingly, an SU monitors communication signals from base stations servicing neighboring cells to determine an appropriate new server for hand-off purposes.

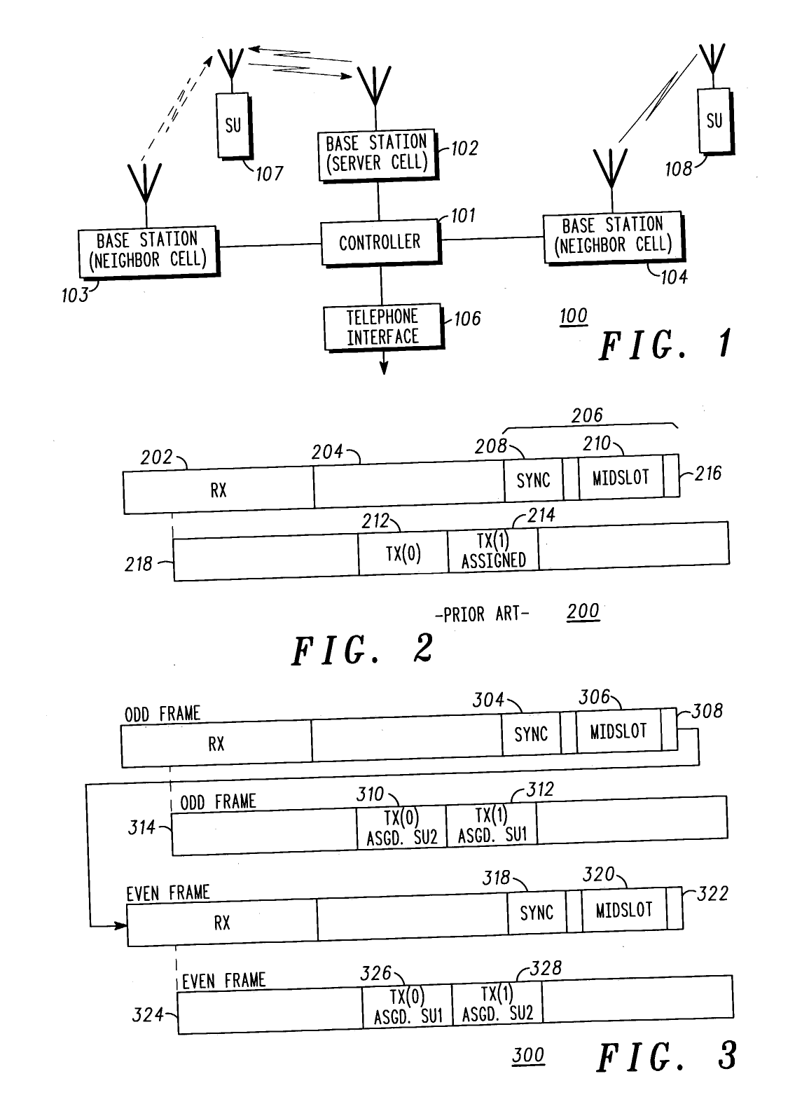

Referring to FIG. 2, a timing diagram 200 depicts communications of a prior-art subscriber unit. The two-way communication channel comprises a receive channel frame 216 used by the SU for receiving, and a transmit channel frame 218 used by the SU for transmitting. Each transmit channel frame 218 preferably starts a predetermined time, e.g., 4 milliseconds, after the start of the corresponding receive channel frame 216. The receive channel frame 216 and the transmit channel frame 218 preferably are on different carrier frequencies. A frame comprises three timeslots. The SU preferably uses the first timeslot 202 of the receive channel frame 216 for receiving communications directed to the SU. During the second timeslot 204 the SU does not receive, but transmits in the transmit channel frame 218 during one of two sub-timeslots, or sub-slots, 212, 214 assigned by a fixed portion, such as the controller 101, of the TDMA communication system.

During the third timeslot 206 of the receive channel frame 216, the SU can monitor the signal quality of a neighbor cell to determine whether a hand-off is desirable. Preferably, a partial neighbor cell signal quality measurement is made, through well-known techniques, during an optimum time period, which includes the first portion 208 of the third timeslot (neighbor slot) 206. The first portion includes or contains the sync and the color code information for the protocol and as is known, yields a more reliable signal quality estimate or measurement. This measurement can be made only when the SU is allocated sub slot TX(0) 212 for its transmissions. A midslot measurement, on the other hand, can be performed in the middle 210 of the neighbor slot 206. However the middle 210 does not include the sync or color code information for the cell and as known is therefore less reliable. Due to overlap, the midslot measurement is required in the prior-art system when the SU is assigned to sub slot TX(1) 214 for its transmissions. In either case, one neighbor cell measurement preferably is obtained by the SU every two TDMA frames.

Unfortunately, the timing diagram 200 indicates that the particular SU represented is allocated TX(1) 214 for its inbound transmission. This SU will NOT be able to perform a partial neighbor cell measurement during the preferred first portion 208 except following a discontinuous transmit (DTX) slot—a slot in which transmission is optional under some conditions. All other signal quality measurements of the neighbor cell will have to take place using the less-desirable midslot measurement.

Referring to FIG. 3, a timing diagram 300 depicts communications of a subscriber unit (SU) in accordance with the present invention. An algorithm which allows the SU to toggle its transmission between the subslot TX(0) and the subslot TX(1) is proposed. This algorithm will allow the SU to perform a partial neighbor cell measurement when transmitting on or during TX(0). The algorithm does not rely on explicit synchronization between the fixed network equipment (FNE) and the SU during the call. The synchronization is obtained from a predetermined order agreed upon during call setup and is maintained with no risk for error between the FNE and SU.

The SU takes advantage of the sequential numbering of TDMA frames to determine its subslot transmission. A total of two subscribers can share the full slot, one on TX(0) and the other on TX(1). One subscriber is assigned TX(0) on odd frame numbers and TX(1) on even frame numbers. The other subscriber is assigned TX(0) on even frame numbers and TX(1) on odd frame numbers. This configuration will cause each SU to ping pong between two transmit subslots and will allow the SU to perform a partial neighbor cell measurement at the optimum time in the frame in which the SU uses TX(0) for transmission. The transmit subslot assignment is done during call setup and is performed by the FNE. Note that the two SUs are operating on the same frequency with the same base station or cell server, in order to take advantage of this procedure.

The SU determines the subslot number as follows:

Subslot_num=(Frame_Number+Subslot_Zero_in_Odd_frame)% 2,

where, Subslot_num is Tx sub-slot, which will be 0 or 1,

Frame_number is the current TDMA frame number,

% is the modulo operator,

Subslot_Zero_in_Odd_Frame is 0 (False) or 1 (True) assigned by the FNE and sent as part of the call setup.

The following table depicts the determination of the subslot number.

| Frame_number | Subslot_Zero_in_Odd_frame | Subslot_num |
|---|---|---|
| Odd | 0 (False) | 1 |
| Even | 0 (False) | 0 |
| Odd | 1 (True) | 0 |
| Even | 1 (True) | 1 |

FIG. 3 depicts an odd-frame 308 of the receive channel, an odd-frame 314 of the transmit channel, an even-frame 322 of the receive channel, and an even-frame 324 of the transmit channel. In the example depicted, the FNE has assigned the first SU to subslot TX(0) 326 in even frames, and to subslot TX(1) 312 in odd frames. The FNE has assigned the second SU to subslot TX(1) 328 in even frames, and to subslot TX(0) 310 in odd frames. This assignment arrangement advantageously permits the first SU to perform a partial neighbor cell measurement during the even-frame sync portion 318 and permits the second SU to perform a partial neighbor cell measurement during the odd-frame sync portion 304. Neither SU is forced to perform a signal quality measurement in the middle 306, 320 of the neighbor slots. Note that, further advantageously, one neighbor cell measurement is obtained by each SU every two TDMA frames—the same rate as in the prior-art.

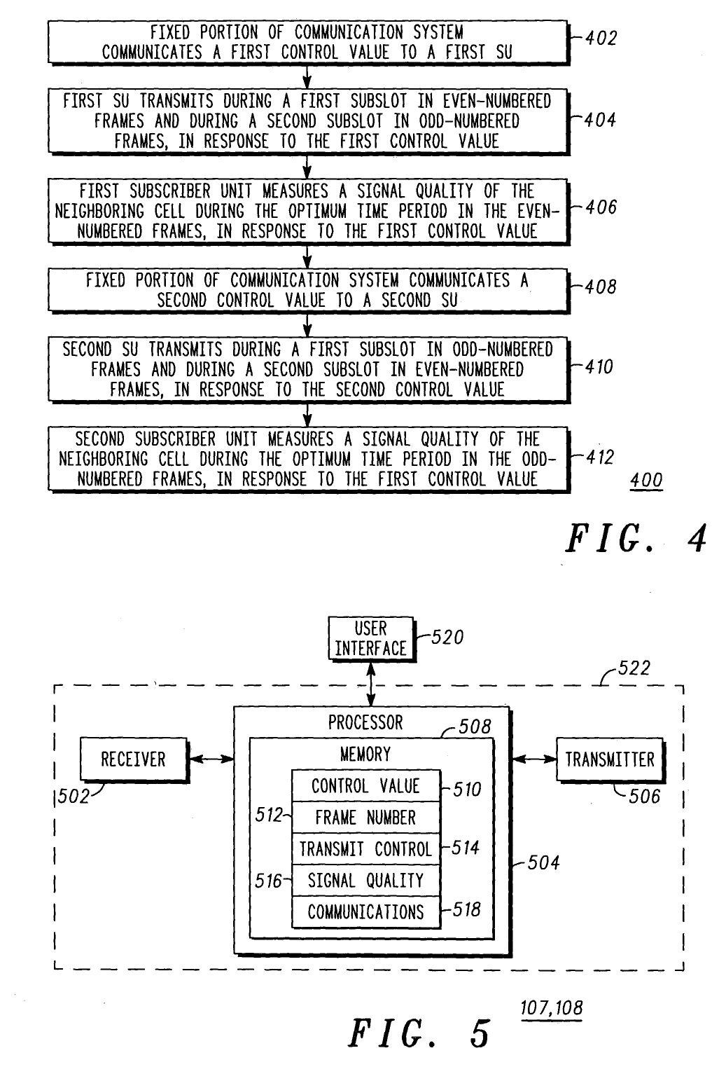

Referring to FIG. 4, a flow chart 400 depicting operation of the TDMA communication system in accordance with the present invention begins with the fixed portion of the communication system 100 communicating 402a first control value to a first SU. In response to the first control value, the first SU transmits 404 during a first subslot 326 in even-numbered frames, and during a second subslot 312 in odd numbered frames. Also in response to the first control value, the first SU measures 406 the signal quality of the neighboring cell during the optimum time period 318 in the even-numbered frames.

The fixed portion of the communication system 100 communicates 408a second control value to a second SU. In response to the second control value, the second SU transmits 410 during a second subslot 328 in even-numbered frames, and during a first subslot 310 in odd numbered frames. Also in response to the second control value, the second SU measures 412 the signal quality of the neighboring cell during the optimum time period 304 in the odd-numbered frames.

The method of operation described herein above advantageously allows all SUs operating in the communication system 100 to measure the signal quality of the neighbor cell at the optimum time for the greatest accuracy. In addition the preferred rate of one neighbor cell measurement every two TDMA frames per SU is maintained.

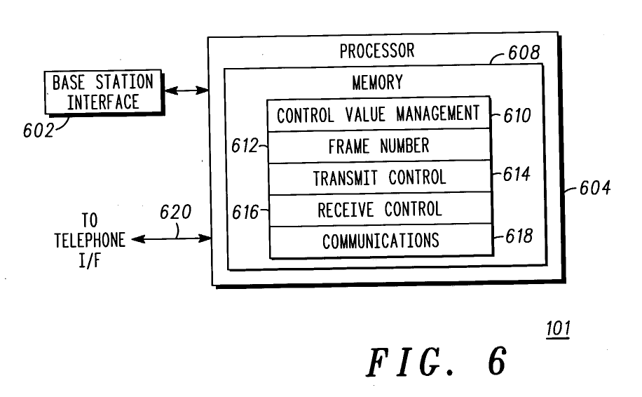

Referring to FIG. 5, an electrical block diagram of the subscriber unit 107, 108 in accordance with the present invention comprises an apparatus 522 for facilitating a signal quality measurement of a neighbor cell in a TDMA communication system having a sequentially-numbered frame structure including first and second subslots TX(0) and TX(1) used for transmissions by the SU 107, 108, the second subslot TX(1) overlapping with an optimum time period (during SYNC and color code) for making the signal quality measurement of the neighbor cell. The apparatus 522 comprises a conventional receiver 502 for receiving, from a fixed portion of the communication system 100, one of a first control value and a second control value. The apparatus 522 further comprises a conventional processor 504 coupled to the receiver 502 for storing and processing the one of the first control value and the second control value and for tracking a current frame number. The processor preferably includes a conventional memory 508 for storing operating software and variables.

The memory 508 includes a control value program 510 for programming the processor 504 to store the one of the first and second control values 510 when received from the fixed portion of the communication system 100. The memory 508 further comprises a frame number program 512 for programming the processor 504 to determine and store the current frame number through well-known techniques. In addition, the memory 508 includes a transmit control program 514 for programming the processor 514 to control a conventional transmitter 506 in accordance with the present invention. The memory 508 also includes a signal quality program 516 for programming the processor 504 to determine, through well-known techniques, and store the signal quality of a neighbor cell in accordance with the present invention. The memory 508 further comprises a communications program 518 for programming the processor 504 to direct the communications of the SU 107 through well-known techniques and in accordance with the present invention.

The apparatus 522 also includes the transmitter 506 coupled to the processor 504 and controlled by the processor 504 to transmit during the first subslot TX(0) in even-numbered frames and during the second subslot TX(1) in odd-numbered frames, in response to receiving the first control value. The processor 504 is arranged and programmed to cooperate with the receiver 502 to measure the signal quality of the neighboring cell during the optimum time period in the even-numbered frames, in response to receiving the first control value.

The processor 504 is further arranged and programmed to control the transmitter 506 to transmit during the first subslot TX(0) in the odd-numbered frames and during the second subslot TX(1) in the even-numbered frames, in response to receiving the second control value. The processor 504 is further arranged and programmed to cooperate with the receiver 502 to measure the signal quality of the neighboring cell during the optimum time period in the odd-numbered frames, in response to receiving the second control value.

The SU 107,108 further comprises a conventional user interface coupled to the processor 504 for interfacing the subscriber unit with a user. The user interface preferably includes such items as a display, e.g., a liquid crystal display, a keypad, and an audible alert device.

Referring to FIG. 6, an electrical block diagram of the controller 101 for facilitating a signal quality measurement of a neighbor cell, by first and second subscriber units (SUs), in a fixed portion of a TDMA communication system having a sequentially-numbered frame structure including first and second subslots used for transmissions by the first and second SUs, the second subslot overlapping with an optimum time period for making the signal quality measurement of the neighbor cell. The controller 101 comprises a conventional base station interface 602 for interfacing with and controlling one of the base stations 102-104 to send a first control value to the first SU and a second control value to the second SU. The controller 101 further comprises a processor 604 coupled to the base station interface 602 for managing assignment of the first and second control values. In addition, the processor 604 controls the base station interface 602 to cooperate with one of the base stations 102-104 to receive a transmission from the first SU 107 during the first subslot in even-numbered frames and during the second subslot in odd-numbered frames, responsive to the first control value sent to the first SU. The processor 604 is also programmed to control the receiver 602 to receive a transmission from the second SU (not specifically depicted but as earlier noted this another SU operating on the same base station and same frequency with the same properties as SU 107, 108) during the first subslot in the odd-numbered frames and during the second subslot in the even-numbered frames, responsive to the second control value sent to the second SU. In addition, the controller 101 includes a link 620, coupled to the processor 604 for communicating with the telephone interface 106.

The processor 604 includes a memory 608 for storing operating software and variables. The memory 608 includes a control value management program 610 for programming the processor 604 to manage the assignment of the first and second control values. The memory 608 further comprises a frame number program 612 for programming the processor 604 to determine and store the current frame number through well-known techniques. In addition, the memory 608 includes a transmit control program 614 for programming the processor 604 to control the base station interface 602 through well-known techniques to send the first and second control values to the first and second SUs.

The memory 608 also includes a receive control program 616 for programming the processor 604 to cooperate with the receiver 602 to receive communications from the first and second SUs in accordance with the present invention. The memory 608 further comprises a communications program 618 for programming the processor 604 to direct the communications of the controller 101 through well-known techniques.

Thus, it should be clear from the preceding disclosure that the present invention provides a method and apparatus for facilitating a signal quality measurement in a TDMA system. One of ordinary skill in the art will recognize the technique disclosed herein is general and can be implemented with many degrees of freedom.

This disclosure is intended to explain how to fashion and use the embodiment(s) in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for facilitating a signal quality measurement of a neighbor cell in a TDMA communication system including a first subscriber unit (SU) and having a sequentially-numbered frame structure including first and second subslots used for transmissions by the first SU, the second subslot overlapping with an optimum time period for making the signal quality measurement of the neighbor cell, the method comprising:
communicating, by a fixed portion of the communication system, a first control value to the first SU; and
transmitting, by the first SU, during the first subslot in even-numbered frames and during the second subslot in odd-numbered frames, in response to the first control value.

2. The method of claim 1, further comprising:
measuring, by the first subscriber unit, a signal quality of the neighboring cell during the optimum time period in the even-numbered frames, in response to the first control value.

3. The method of claim 1, wherein the communication system includes a second SU, the method further comprising:
communicating, by the fixed portion of the communication system, a second control value to the second SU; and
transmitting, by the second SU, during the first subslot in the odd-numbered frames and during the second subslot in the even-numbered frames, in response to the second control value.

4. The method of claim 3, further comprising:
measuring, by the second subscriber unit, a signal quality of the neighboring cell during the optimum time period in the odd-numbered frames, in response to the second control value.

5. An apparatus for use in a subscriber unit (SU) for facilitating a signal quality measurement of a neighbor cell in a TDMA communication system having a sequentially-numbered frame structure including first and second subslots used for transmissions by the SU, the second subslot overlapping with an optimum time period for making the signal quality measurement of the neighbor cell, the apparatus comprising:
a receiver for receiving signals;
a processor, coupled to the receiver, for storing and processing one of a first control value and a second control value and for tracking a current frame number; and
a transmitter, coupled to the processor and controlled by the processor, to transmit during the first subslot in even-numbered frames and during the second subslot in odd-numbered frames, in response to the first control value.

6. The apparatus of claim 5,
wherein the processor is arranged and programmed to cooperate with the receiver to measure a signal quality of the neighboring cell during the optimum time period in the even-numbered frames, in response to the first control value.

7. The apparatus of claim 5,
wherein the processor is arranged and programmed to control the transmitter to transmit during the first subslot in the odd-numbered frames and during the second subslot in the even-numbered frames, in response to the second control value.

8. The apparatus of claim 5,
wherein the processor is arranged and programmed to cooperate with the receiver to measure a signal quality of the neighboring cell during the optimum time period in the odd-numbered frames, in response to the second control value.

9. The apparatus of claim 5,
wherein the receiver is further for receiving, from a fixed portion of the communication system, the one of the first control value and the second control value.

10. A controller for facilitating a signal quality measurement of a neighbor cell, by first and second subscriber units (SUs), in a fixed portion of a TDMA communication system having a sequentially-numbered frame structure including first and second subslots used for transmissions by the first and second SUs, the second subslot overlapping with an optimum time period for making the signal quality measurement of the neighbor cell, the controller comprising:
a base station interface controlled by a processor to cooperate with a base station to send a first control value to the first SU and a second control value to the second SU; and
the processor coupled to the base station interface for controlling the base station interface and for managing assignment of the first and second control values,
wherein the processor is programmed to further control the base station interface to cooperate with the base station to receive a transmission from the first SU during the first sub-slot in even-numbered frames and during the second sub-slot in odd-numbered frames, responsive to the first control value sent to the first SU.

11. The controller of claim 10, wherein the processor is further programmed to control the base station interface to cooperate with the base station to receive a transmission from the second SU during the first sub-slot in the odd-numbered frames and during the second sub-slot in the even-numbered frames, responsive to the second control value sent to the second SU.

12. A subscriber unit for facilitating a signal quality measurement of a neighbor cell in a TDMA communication system having a sequentially-numbered frame structure including first and second subslots used for transmissions by the subscriber unit, the second subslot overlapping with an optimum time period for making the signal quality measurement of the neighbor cell, the subscriber unit comprising:
a receiver for receiving signals;
a processor coupled to the receiver for storing and processing one of a first control value and a second control value and for tracking a current frame number;
a transmitter coupled to the processor and controlled by the processor to transmit during the first subslot in even-numbered frames and during the second subslot in odd-numbered frames, in response to the first control value; and
a user interface coupled to the processor for interfacing the subscriber unit with a user.

13. The subscriber unit of claim 12,
wherein the processor is arranged and programmed to cooperate with the receiver to measure a signal quality of the neighboring cell during the optimum time period in the even-numbered frames, in response to the first control value.

14. The subscriber unit of claim 12,
wherein the processor is arranged and programmed to control the transmitter to transmit during the first subslot in the odd-numbered frames and during the second subslot in the even-numbered frames, in response to the second control value.

15. The subscriber unit of claim 12,
wherein the processor is arranged and programmed to cooperate with the receiver to measure a signal quality of the neighboring cell during the optimum time period in the odd-numbered frames, in response to the second control value.

16. The subscriber unit of claim 12,
wherein the receiver is further for receiving, from a fixed portion of the communication system, the one of the first control value and the second control value.
